(19) United States
(12) Patent Application Publication
(10) Pub. No.: US 2021/0213977 A1
(43) Pub. Date: Jul. 15, 2021

(54) Nearby Driver Intent Determining Autonomous Driving System

(71) Applicant: Allstate Insurance Company, Northbrook, IL (US)

(72) Inventor: Juan Carlos Aragon, Redwood City, CA (US)

(21) Appl. No.: 17/143,715

(22) Filed: Jan. 7, 2021

Related U.S. Application Data
(60) Provisional application No. 62/961,050, filed on Jan. 14, 2020.

(51) Int. Cl. B60W 60/00; B60W 30/095; G06K 9/00; G06N 3/08; G06K 9/62

(52) U.S. Cl. CPC B60W 60/00274; B60W 60/00272; B60W 60/0017; B60W 30/0956; B60W 30/0953; B60W 2420/42; G06N 3/08; G06K 9/6256; B60W 2554/4049; B60W 2554/4045; G06K 9/00798

(57) ABSTRACT

An autonomous driving system capable of determining an intent of a nearby human driver and taking an action to avoid a collision is presented. The system may receive a current state of a nearby vehicle, determine an expected action of a human driver of the nearby vehicle by determining a result of a reward function, the reward function being a linear combination of feature functions, where each feature function is a neural network which has been trained to reproduce a corresponding algorithmic feature function, and based on the determined expected action of the human driver, taking an action to avoid a collision.

### CROSS REFERENCE TO RELATED APPLICATIONS

This application claims priority to and the benefit of U.S. Provisional Patent Application No. 62/961,050 filed on Jan. 14, 2020, the disclosure of which is incorporated herein by reference in its entirety.

### FIELD OF ART

Aspects of the disclosure generally relate to one or more computer systems and/or other devices including hardware and/or software. In particular, aspects of the disclosure generally relate to determining, by an autonomous driving system, an intent of a nearby driver, in order to act to avoid a potential collision.

### BACKGROUND

Autonomous driving systems are becoming more common in vehicles and will continue to be deployed in growing numbers. These autonomous driving systems offer varying levels of capabilities and, in some cases, may completely drive the vehicle, without needing intervention from a human driver. At least for the foreseeable future, autonomous driving systems will have to share the roadways with non-autonomous vehicles or vehicles operating in a non-autonomous mode and driven by human drivers. While the behaviors of autonomous driving systems may be somewhat predictable, it remains a challenge to predict driving actions of human drivers. Determining human driver intent is useful in predicting driving actions of a human driver of a nearby vehicle, for example, in order to avoid a collision with the nearby vehicle. Accordingly, in autonomous driving systems, there is a need for determining an intent of a human driver.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure relate to machine learning and autonomous vehicles. In particular, aspects are directed to the use of reinforcement learning to identify intent of a human driver. In some examples, one or more functions, referred to as “feature functions” in reinforcement learning settings, may be determined. These feature functions may enable the generation of values that can be used in the construction of an approximation of a reward function, that may influence automobile driving actions of a human driver.

In some aspects, the feature functions may be weighted to form a reward function for predicting the actions of a human driver. The reward function, together with positional information of a nearby vehicle, may be used by the autonomous driving system to determine an expected trajectory of a nearby vehicle, and, in some examples, to act to avoid a collision.

The reward function, in some aspects, may be a linear combination of neural networks, each neural network trained to reproduce a corresponding algorithmic feature function.

### BRIEF DESCRIPTION OF THE DRAWINGS

The present invention is illustrated by way of example and is not limited by the accompanying figures in which like reference numerals indicate similar elements and in which:

FIG. 1 illustrates an example computing device that may be used in accordance with one or more aspects described herein.

FIG. 2 illustrates an exemplary weight learning method for a linear reward in accordance with one or more aspects described herein.

FIG. 3 illustrates an exemplary method for feature learning with linear reward using a neural network pre-trained with user data in accordance with one or more aspects described herein.

FIG. 4 illustrates an example neural network trained on a closed form expression in accordance with one or more aspects described herein.

FIG. 5 illustrates an example reward function based on multiple neural networks trained with closed form expressions in accordance with one or more aspects described herein.

FIG. 6 illustrates an example method for feature learning with linear reward using neural networks pre-trained on closed form expressions in accordance with one or more aspects described herein.

FIG. 7 depicts an autonomous driving system in an autonomous vehicle in accordance with one or more example embodiments.

FIG. 8 illustrates an exemplary method in accordance with one or more aspects described herein.

### DETAILED DESCRIPTION

In accordance with various aspects of the disclosure, methods, computer-readable media, software, and apparatuses are disclosed for determining a reward function comprising a linear combination of feature functions, each feature function having a corresponding weight, wherein each feature function comprises a neural network. In accordance with various aspects of the disclosure, the reward function may be used in an autonomous driving system to predict an expected action of a nearby human driver.

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

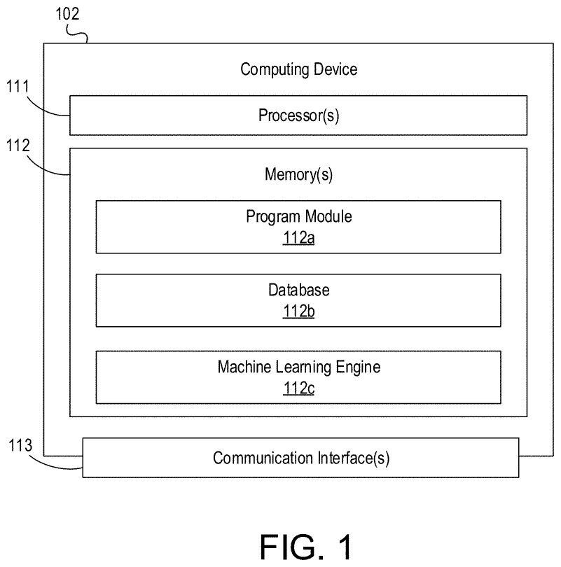

Referring to FIG. 1, a computing device 102, as may be used in accordance with aspects herein, may include one or more processors 111, memory 112, and communication interface 113. A data bus may interconnect processor 111, memory 112, and communication interface 113. Communication interface 113 may be a network interface configured to support communication between computing device 102 and one or more networks. Memory 112 may include one or more program modules having instructions that when executed by processor 111 cause the computing device 102 to perform one or more functions described herein and/or one or more databases that may store and/or otherwise maintain information which may be used by such program modules and/or processor 111. In some instances, the one or more program modules and/or databases may be stored by and/or maintained in different memory units of computing device 102 and/or by different computing devices. For example, in some embodiments, memory 112 may have, store, and/or include program module 112a, database 112b, and/or a machine learning engine 112c. Program module 112a may comprise a sub-system module which may have or store instructions that direct and/or cause the computing device 102 to execute or perform methods described herein. In some embodiments, a machine learning engine 112c may have or store instructions that direct and/or cause the computing device 102 to determine features, weights, and/or reward functions as disclosed herein. In some embodiments, the computing device 102 may use the reward function to determine an intent of a nearby human driver.

As noted above, different computing devices may form and/or otherwise make up a computing system. In some embodiments, the one or more program modules described above may be stored by and/or maintained in different memory units by different computing devices, each having corresponding processor(s), memory(s), and communication interface(s). In these embodiments, information input and/or output to/from these program modules may be communicated via the corresponding communication interfaces.

Aspects of the disclosure are related to the determination of specific functions called “feature functions” which may be used to generate another type of function known in reinforcement learning settings as a “reward function” or “utility function.” The reward function may, in some embodiments, be expressed as a linear combination of feature functions. Coefficients or weights used to generate the linear combination allow determining the degree of importance that the individual feature function has on the final reward. The equation below captures the above-mentioned relationships for an exemplary reward function R. In this equation, the terms wᵢ represent the weights and the terms fᵢ represent the feature functions.

R=w₁f₁+w₂f₂+ . . . +w_{N}f_{N}

Whether an increasing value of any feature function contributes as a positive reward or a negative reward may be determined by the sign of the associated weight.

Reward functions may be used in applications where a teacher/critic component is needed in order to learn the correct actions to be taken by an agent, so that such agent can successfully interact with the environment that surrounds the agent. The most common applications of this scheme can be found in robots that learn to perform tasks such as gripping, navigating, driving a vehicle, and others. In this sense, aspects disclosed herein can be applied to any application that involves a reward function.

In the area of autonomous driving, it may be beneficial to predict actions that human drivers sharing a road with one or more autonomous or semi-autonomous vehicles may potentially take, so that the autonomous vehicle can anticipate potentially dangerous situations and execute one or more mitigating maneuvers. In order to predict human driver actions, a model of human intent is needed. If the generation of human driver actions is approximated/modeled as a reinforcement learning system, so that a prediction of such driving actions is possible through computer processing, then a reward function may provide the capability to capture human intentions, which may be used to determine/predict the most likely human driving action that will occur. Accordingly, aspects disclosed herein provide the ability to develop and use such a reward function that captures human intentions.

As discussed above, a reward function may be based on at least two types of components: the feature functions and the weights. The feature functions may provide an output value of interest that captures a specific element of human driving which influences human driver action. For example, one feature function may provide the distance of an ego-vehicle (e.g. the human driver's vehicle) to a lane boundary. In this case, as the distance to the lane boundary decreases, the human driver may be pressed to correct the position of the vehicle and return to a desired distance from the lane boundary. In this sense, the driver's reward will be to stay away from the boundary as much as possible, and this situation may be modeled as the feature function that delivers such a distance. As the output of this feature function increases, then the reward increases, and this may be captured by having a positive weight assigned to the output of this feature function. The human driver may tend to perform driving actions that will increase his/her reward. The degree to which the distance to the boundary will be important to the human driver, and thus influence his driving actions, may be captured by the magnitude of the weight.

Another example feature function may deliver the desired speed for the human driver. The human driver will usually tend to increase his/her driving speed as much as possible towards the legal speed limit. A feature function that generates, as output, the difference between the legal speed limit and the current speed may provide another contributor towards human driver reward. In this case, the driver will increase his/her reward and a higher speed will be a positive reward, thus the lower the output, the higher the reward (since the reward is not the current speed but the difference between the current speed and the speed limit). As the output of this feature function increases, the human reward will decrease, therefore the associated weight should be negative in this case. This way, the incentive for the human driver will be to keep the output of this feature function as low as possible, so that the human driver speed is as high as possible. The higher the value of the feature function, the lower the reward, and thus a negative weight will provide this effect, since the contribution of this feature function towards the total reward will be to decrease its value.

The learning of a reward function that captures human driver intentions is not a straight forward task. One approach to learn such a reward function is to use Inverse Reinforcement Learning techniques, which infer the reward function from driving action demonstrations that a human user provides. In this case, the driving actions may be used to determine the most likely reward function that would produce such actions. One important drawback of this technique is that, due to several factors, human drivers are not always able to produce driving demonstrations that truly reflect their desired driving. Such factors may relate to limitations of the vehicle in some cases, for example, and the lack of the human driver's expertise to realize the driving actions as intended. Since a more clear and reflective reward function should capture the intended action, then Inverse Reinforcement Learning doesn't seem to deliver the true reward function intended by the driver.

Another reward function inference approach is preference-based learning and, in this case, the true driver's intended driving can be captured regardless of driving expertise, vehicle constrains, and other limitations.

Preference-based learning includes showing, to the human driver and via a computer screen, two vehicle trajectories that have been previously generated. The human driver selects the vehicle trajectory that he/she prefers between the two. This step represents one query to the human driver. By showing several trajectory pairs to the human driver, it is possible to infer the reward function from information obtained from the answers to the queries. For example, one query could be composed of two trajectories, one which is closer to the lane boundary than the other. By selecting the trajectory that is farther away from the lane boundary, the human driver has provided information about his preferred driving and has provided a way to model this preferred driving with a reward function that penalizes getting closer to the lane boundary (for example, the weight of the reward function will tend to be positive). The feature functions used for the reward function may be pre-determined and may be hand-coded. The examples of features functions described are merely some examples and other potential feature functions, such as keeping speed, collision avoidance, keeping vehicle heading, and maintaining lane boundary distance, among others, may be provided without departing from the invention.

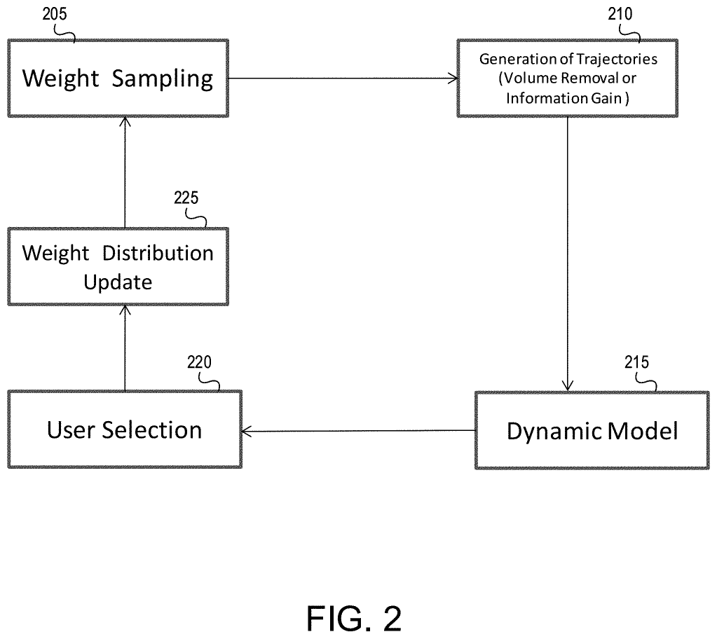

FIG. 2 illustrates an exemplary weight learning method for a linear reward comprising hand-coded feature functions in accordance with one or more aspects described herein. Such a reward function may be used in an autonomous driving system, for example, implemented using computing device 102. In some embodiments, the process of reward learning based on preferences may consist of determining the values of weights associated with the hand-coded features that may more accurately reflect the driving preferences and thus capture driving intentions. In some embodiments, this learning process may be based on five processing steps, as shown in FIG. 2. At step 205 an a priori probability distribution p(w) for the weights of the reward function may be assumed, and the weight space may be sampled according to the probability distribution. At step 210 two trajectories, as discussed above, may be generated that will be part of a query for the human user. The generation of the trajectories may be performed with the aim to reduce the uncertainty in the determination of the weights, and for this purpose, an optimization process may be performed to search for two trajectories that will reduce such an uncertainty. Methods that may be used for this purpose include Volume Removal and Information Gain. These methods may search for the pair of trajectories that will minimize an objective function based on the current guess of the weight distribution, the sequence of driving actions that are part of the trajectory, and the feature functions that are part of the reward function. The goal of the minimization is to find the driving actions (for example, vehicle acceleration and vehicle heading) that provide the minimum value to the objective function and thus reduce the uncertainty.

Once the driving actions are found, then at step 215, a dynamic model may produce parameters such as vehicle position, vehicle speed, and others, by performing physics calculations aimed to reproduce the vehicle state after the driving actions have been applied to it. The output of the dynamic model may then be applied as input to step 220, which is user selection, which, in some embodiments, may produce a graphical animation of the trajectories which are based on the sequence of vehicle states. Once the trajectories are generated, they may be presented (for example, using a computer screen) to the human user and he/she may select which of the two trajectories he/she prefers.

The output of the user selection 220 may be used in step 225 to update the probability distribution of the weights p(w). This update may be performed by multiplying the current probability distribution of the weights by the probability distribution of the user selection conditioned to the weights p(sel|w). The effect of performing this multiplication is that within the weight space (i.e., the space formed by all the possible values that the weights could take) these regions where the weights generate a lower p(sel|w) probability are penalized by reducing the resulting value of p(w|sel), which is effectively used as p(w)≅p(w|sel) for the next query. This completes one iteration and the process may start again with the sampling of the weight space according to the current probability distribution p(w). The goal is that after a number of queries the true p(w) may be obtained. The final weights for the feature functions may be obtained as the mean values (one mean value for each dimension of the weight vector) of the last sampling of the weight space (vector space) performed with the final p(w) obtained after the last query.

As can be understood, the learning method illustrated in FIG. 2 may arrive at one or more final weight values. There is however a drawback for this process, since the hand-coded features may not be optimal in order to capture human intent. These features may be based on mathematical expressions that were defined a priori and that have not been corroborated to be the ones that best represent human intent.

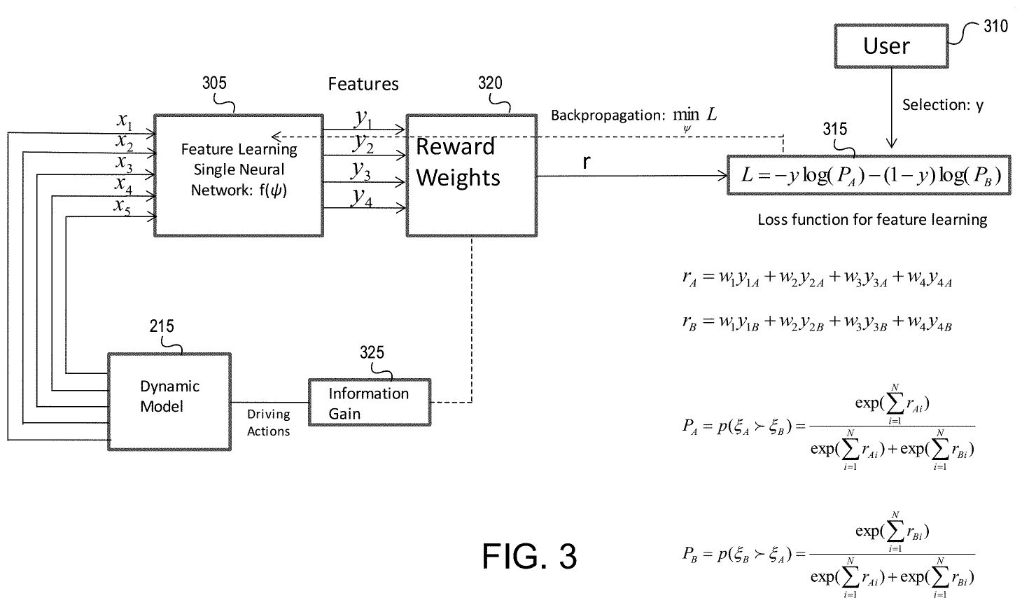

In some embodiments, as shown in FIG. 3, an alternative to using hand-coded features may include learning these features, together with learning the weights. One approach for this learning process is to replace all of the hand-coded features with a single neural network 305 that uses, as inputs, the state of the vehicle x₁-x₅ (defined by a vector with components such as the X, Y position of the vehicle within the road, the current vehicle speed, and others) and that generates, as output, a vector with components filled by the features values. The neural network 305 may be implemented in machine learning engine 112c of computing device 102. The learning process in these embodiments may be iterative, where the neural network may be first pre-trained based on the selections of a given human user 310 to a group of queries (also, the selections of more than one user may be used). Here, the neural network training may be performed through backpropagation and by minimizing an objective function defined by a log likelihood function 315 composed of the rewards from each segment of the two trajectories used to perform the query. The equation below defines this likelihood function.

L=−y log(P_{A})−(1−y)log(P_{B})

Referring to the equation above, y represents the user selections and P_{A} represents the probability that the user selected the first of the two trajectories presented to the user according to a softmax representation. The softmax representation may be composed of the accumulated reward for each of the two trajectories. Another part of the softmax representation may include the weights 320 of the reward function r. These weights may be assumed to be the final weights obtained by the human user at the end of a weight learning process using hand-coded features as was described above. The equation below provides the expression for the softmax representation.

$${P}_{A} = p ( {ξ}_{A} ϕ {ξ}_{B} ) = \frac{exp ( {\sum }_{i = 1}^{N} {r}_{Ai} )}{exp ( {\sum }_{i = 1}^{N} {r}_{Ai} ) + exp ( {\sum }_{i = 1}^{N} {r}_{Bi} )}$$

In the equation above, the terms r_{Ai} represent the rewards obtained at each state in trajectory A (the trajectories presented to the user are designated as A and B), and r_{Bi} represent the rewards obtained at each state in trajectory B. The index “i” in the summatory represents the state in the trajectory. The trajectory is made of N states. The expression for a single state in trajectory A (for example) is provided below.

r_{A}=w₁y_{1A}+w₂y_{2A}+w₃y_{3A}+w₄y_{4A}

With a pre-trained neural network, the process for simultaneous weight learning and feature learning may start. In this case, the user for which the simultaneous learning is performed is usually different than the user that was used to pre-train the neural network. The iterative process may start by first keeping the pre-trained neural network 305 fixed, and training the weights 320 for a number of queries, such as 20 queries, for example (other numbers of queries are also contemplated). As discussed above, for each query, two trajectories may be generated that will be part of the query for the human user. The generation of the trajectories may be performed with the aim to reduce the uncertainty on the determination of the weights, and for this purpose, an optimization process may be performed to search for two trajectories that will reduce such an uncertainty. Methods that may be used for this purpose may include Volume Removal and Information Gain (Information Gain 325 is depicted in FIG. 3). After this, the final weights 320 achieved after the, for example, 20 queries are kept fixed and the neural network 305 is trained with the inputs coming from the trajectories from the previous 20 queries and the previous 20 user selections, according to the training procedure described previously. Once the neural network 305 is trained, the neural network 305 may be kept fixed and the weight learning process resumes, but this time with the modified neural network. The weight learning process may continue for another 20 queries and the final weights 320 may be kept fixed while the neural network 305 is trained with the data from the previous 40 queries. This iterative procedure may continue. After a given number of total learning sequences for both neural network 305 and weights 320, the finally achieved feature functions are learned for this user together with the weights 320 that correspond to the feature functions that are finally learned by the neural network 305.

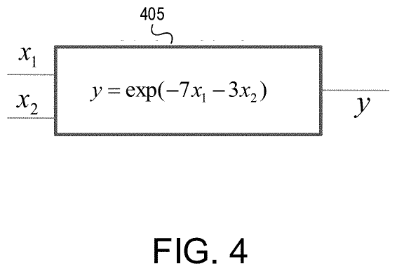

In some embodiments, a variation of the simultaneous learning procedure described above may be used. In these embodiments, instead of using a single neural network 305 to deliver all of the feature outputs, multiple neural networks may be used, each delivering one individual feature. For example, shown in FIG. 4, one of the neural networks may be dedicated to deliver a feature function similar to the one related to keeping the speed of the vehicle, discussed above. In this example, the neural network is not pre-trained with data from user selections. Instead, the neural network is trained to reproduce the actual formula that would have been used in the hand-coded feature. For example, neural network 405 receives positional inputs x₁ and x₂ and outputs feature value y. Accordingly, each neural network may be trained to implement one of the given closed form expressions used for the hand-coded features. Once these neural networks are trained, these neural networks may be used in the simultaneous feature learning and weight learning approach that was described previously.

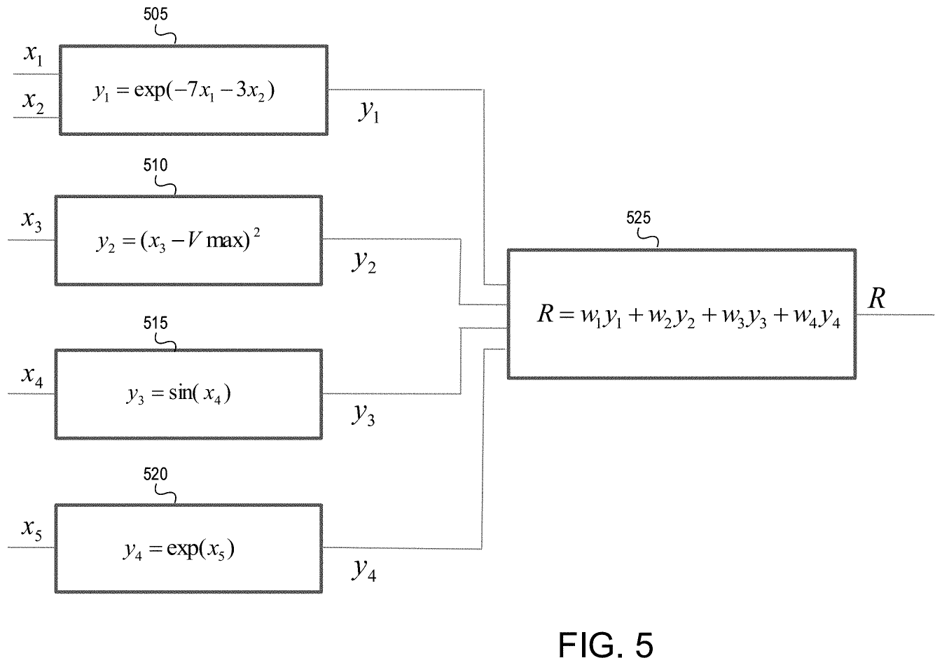

FIG. 5 illustrates how the multiple neural networks may be used to deliver the individual feature functions to produce the reward function 525. For example, neural network 505 may reproduce the formula for the hand-coded feature for keeping the speed of the vehicle, neural network 510 may reproduce the formula for the hand-coded feature for collision avoidance, neural network 515 may reproduce the formula for the hand-coded feature for keeping vehicle heading, and neural network 520 may reproduce the formula for the hand-coded feature for maintaining lane boundary distance. The neural networks 505-520 receive as input positional values x₁-x₅ and output feature values y₁-y₄.

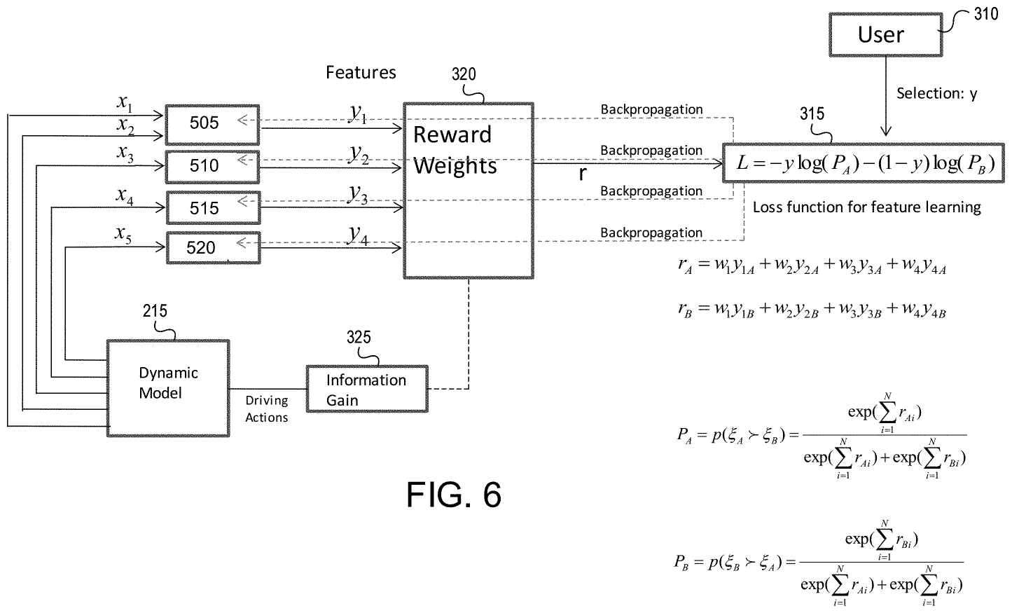

FIG. 6 illustrates the feature learning process for the neural networks depicted in FIG. 5. For the learning process at the initial cycle of the method, when the neural network is kept fixed, the situation may be almost exactly the same as the case of weight learning with hand-coded features, except that instead of having mathematical expressions delivering the outputs of the feature functions, corresponding neural networks may perform those aspects. Therefore, the initial cycle of learning the weights through the first 20 queries may be the same as the process of learning the weights with hand-coded features. Once the 20 queries have been presented to the user, the final weights after the 20 queries may be kept fixed (and may have achieved some mature value), then the neural networks are engaged in individual training in a similar way as was described previously. Each neural network training seeks to minimize the log-likelihood function, achieving a feature function that explains as much as possible the previous 20 user queries. After training of all the neural networks are finished, then weight learning may be re-engaged for an additional 20 queries. After this process is completed, the final weights after the 40 queries may be kept fixed and the neural network may be trained again. One important distinction between this training and the previous training discussed in relation to FIG. 3 is that the neural network here may be loaded with the best possible model known, which is the hand-coded formula, then any training that follows may modify this model accordingly, to approximate the best possible model that explains better the user choices and that allows the best possible prediction of the user selections. Here we have a scenario where the base knowledge which is provided by the formula of the hand-coded feature is the starting point for the neural network training. Therefore, the model that is developed through the subsequent neural network training is developed around the initial formula or algorithm and allows an extension of this formula, to achieve a better final expression.

In case a single neural network is used, as in FIG. 3, the neural network may develop the model completely from scratch. This situation is similar to what is usually found generally in all the machine learning applications and that prompts the neural network to develop internal functions that are largely incomprehensible, which fits the usual “black box” consideration for the neural network model. This scenario has risen over the years to the point where the field of Artificial Intelligence (AI) explainability has reached prominence in the area of AI safety.

The methodology that works with neural networks pre-trained on closed form mathematical expressions addresses the need for AI explainability, since with the methods disclosed herein, it may be possible and tractable to obtain an explainable final neural network model that was generated by modifying a known expression. In this case, the neural network training will seek to adapt the closed form mathematical expression to improve the predictive capability of the softmax representation.

The adaptations performed over the known mathematical expression can be tracked down by obtaining the final neural network model and obtaining a mathematical expression that relates the inputs and the output. First, it may be advantageous to do this because, as discussed above, the initial pre-trained model is a well-defined mathematical expression itself. Second, it may be possible or advantageous to perform feature identification, in contrast to the method discussed above that uses one single neural network to generate the four feature outputs.

In the case of pre-training with closed form expressions, each of the individual neural networks develops a final concept that may be necessarily related to the pre-trained concept. For example, the neural network that is pre-trained on collision avoidance will develop a final model still related to collision avoidance, but improved by the training (the inputs of the network are the same for the original collision avoidance closed form expression). The neural network will react during training to information related to collision avoidance by virtue of its inputs and its pre-trained model.

More specifically, during training, errors brought by discrepancies between the label output and the pre-trained model based on the mathematical expression may be used to modify the internal parameters of the neural network, which may maintain the relevance of this pre-trained model on the final model achieved after training is completed. Given these considerations, Fourier analysis may be used with the goal of obtaining an expression on the final model achieved by the neural network. In this case, a representative function may be generated by taking the range of values for the network inputs (which become the inputs to the representative function) and obtaining the neural network output (which becomes the output of the representative function) for each data point in the input range. This may be a discrete function, because the range of values may be captured at some fixed step. The Fourier transform of the representative function may be obtained using DFT (Digital Fourier Transform) methods. The process may then eliminate the least significant Fourier coefficients so that the most important frequency content is considered, take the Inverse Digital Fourier Transform (IDFT), and arrive to the mathematical final expression for the neural network (even though it may not be a closed form expression). Eliminating the least significant Fourier coefficients may aid in removing least important components of the representative functions, such as high frequency components, and achieve a more general representation of the final neural network output. In some embodiments, another way to arrive at a more general representation of the final representative function may be to eliminate the weights that have negligible value in the neural network.

Further, the neural networks that are part of the methodology presented herein may go through types of trainings that are of a different nature. The first type of training may be to approximate, as close as possible, a closed form mathematical expression. The second type of training may be to improve the predictability of the softmax representation. The label data for these types of trainings may be different. In the first case, the labels may be provided by the output of the closed form mathematical expression over the input range. In the second case, the labels may be provided by the selections performed by the human user over the two trajectories presented in each query.

The final feature models obtained by the methods disclosed herein may depend on the data provided by the human user who selects the trajectory according to his/her preferences. Because it is desirable to have feature models that are as general as possible, in some embodiments, training may be performed with multiple human users. One such approach may be to train with multiple users, with reinforcement. In this case, training may be performed with data from one user at a time and an iterative procedure, as discussed above, may be executed. Then, before training with a second user, the neural networks may be loaded with the final models achieved with the first user. Then, after the second user is engaged and the neural networks are trained for the second user, the data for the first user may be kept (the data involves the inputs to the neural networks for each query, the selections that such user made for his queries, and the final reward weights achieved for this first user) and the neural networks may also be trained with this data according to the procedure described above. This way, all of the data may be considered, all of the time, and the neural networks may become generalized to all of the involved users, rather than specialized to an individual user. This process may be extended for more than two users by including, similarly, all of the training data as the number of users is increased. In some embodiments, multiple user training may be addressed by training the neural networks on each user individually and averaging the internal parameters of all of the involved neural networks to arrive at a final neural network.

In some examples, through all trainings, the weights of the reward functions may need to be adjusted for the specific feature functions involved. Accordingly, it may be advantageous for the weight learning and the feature learning to occur simultaneously. When training is performed with more than one user according to the reinforcement procedure discussed above, the feature functions may change when going from the first user to the second user (or other additional user). In this case, when re-training on the data for the first user, the first user's final reward weights (achieved on his/her training) may be used. Even though the feature models may change (from the models achieved for the first user) when using the data of the second user, the first user's final reward weights may still be valid, since the general concept of the feature model should not change. Nevertheless, these final reward weights for the first user may be permitted to change according to back-propagation training that may attempt to continuously improve predictability for the first user's data (in this case, back-propagation only changes the first user's reward's weights) through the log likelihood model discussed above. Accordingly, training both the neural networks and the reward weights for the first user's data using backpropagation in an iterative way: first using backpropagation to train the neural networks and then using backpropagation to train the reward weights, may be used (e.g., reinforcement learning). In the case of the data being generated for the second user, his/her reward weights may be modified according to the procedure that uses the generation of trajectories and the weight sampling steps discussed above. The feature model may be trained through backpropagation, as described previously, every 20 queries (for example).

In accordance with aspects described herein, it may be possible to explain not only the final neural network model, but also to explain the training. Since the data that was used to train the neural networks at each query is available, generating the representative functions after applying Fourier analysis at each query may be enabled. This can provide a history of how the original mathematical expression that was pre-trained in the neural network has been modified. This enables observation of how the representative function evolves through training (either comparing the frequency content of the representative function or the actual waveform). Similarly, this enables observation of modifications to the representative function and to relate them to the actual query that influenced that modification and find some explanations for why these modifications happened.

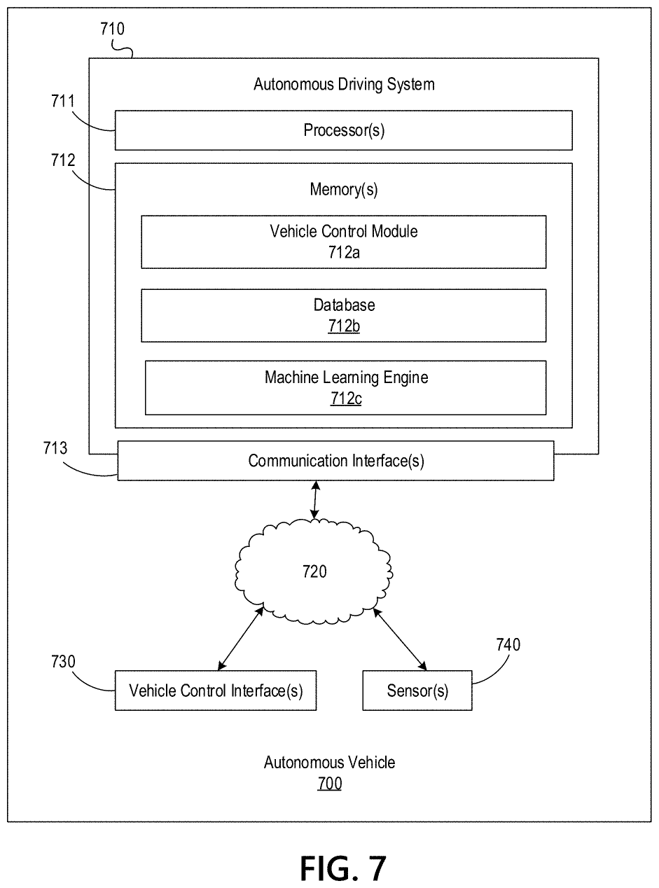

FIG. 7 depicts an autonomous driving system 710 in an autonomous vehicle 700 in accordance with one or more example embodiments. In some embodiments, the autonomous driving system 710 may be implemented using a computing device, such as the computing device 102 of FIG. 1. For example, the autonomous driving system 710 include one or more processors 711, memory 712, and communication interface 713. A data bus may interconnect processor 711, memory 712, and communication interface 713. Communication interface 713 may be a network interface configured to support communication between autonomous driving system 710 and one or more networks in-vehicle networks. Memory 712 may include one or more program modules having instructions that when executed by processor 711 cause the autonomous driving system 710 to perform one or more functions described herein and/or one or more databases 712b that may store and/or otherwise maintain information which may be used by such program modules and/or processor 711. The program modules may include a vehicle control module 712a which may have or store instructions that direct and/or cause the autonomous driving system 710 to execute or perform methods described herein. A machine learning engine 712c may have or store instructions that direct and/or cause the autonomous driving system 710 to determine feature values or reward functions as disclosed herein. In some embodiments, the autonomous driving system 710 may use the reward function to determine an intent of a nearby human driver.

For example, the machine learning engine 712c may implement the neural network 305 of FIG. 3 or the neural networks 505-520 of FIG. 6 and, in some embodiments, may apply the reward weights 320. Based on positional information of a nearby vehicle, which may be input to the neural networks 505-520, the autonomous driving system 710 may determine an intent of a human driver of the nearby vehicle. For example, the neural networks 505-520 and the reward weights 320 may make up the components of the reward function r, which may be used by the autonomous driving system 710 in determining human driver intent of a driver of a nearby vehicle.

In some embodiments, the vehicle control module 712a may compute the result of the reward function, determine actions for the vehicle to take, and cause the vehicle to take these actions. As discussed above, various sensors 740 may determine a state of a nearby vehicle. The sensors 740 may include Lidar, Radar, cameras, or the like. In some embodiments, the sensors 740 may include sensors providing the state of the ego-vehicle, for example for further use in determining actions for the autonomous vehicle to take. These sensors may include one or more of: thermometers, accelerometers, gyroscopes, speedometers, or the like. The sensors 740 may provide input to the autonomous driving system 710 via network 720. In some embodiments, implemented without a network, the sensors 740 may be directly connected to the autonomous driving system 710 via wired or wireless connections.

Based on inputs from the sensors 740, the autonomous driving system 710 may determine an action for the vehicle to take. For example, the information from the sensors 740 may be input to neural network 305 or neural networks 505-520, depending on the embodiment, to obtain the features yᵢ, and the corresponding reward weights wᵢ may be applied to obtain the reward function r. Through evaluation of the reward function, the autonomous driving system 710 may determine an intent of the human driver of the nearby vehicle. Based on the intent of the human driver of the nearby vehicle, the autonomous driving system 710 may determine that an action is needed to avoid a dangerous situation, such as a collision. Accordingly, the autonomous driving system 710 may determine an action to take to avoid the dangerous situation. For example, the autonomous driving system 710 may determine that, due to the result of the reward function, a human driver of a nearby vehicle directly ahead of the ego-vehicle is likely to stop suddenly, and the autonomous driving system 710 may therefore determine to apply the brakes, in order to avoid colliding with the rear of the nearby vehicle.

After determining the action for the vehicle to take, the autonomous driving system 710 may send commands to one or more vehicle control interfaces 730, which may include a brake interface, a throttle interface, and a steering interface, among others. The vehicle control interfaces 730 may include interfaces to various control systems within the autonomous vehicle 700. The commands may be sent via network 720, or the commands may be communicated directly with the vehicle control interfaces 730 using point-to-point wired or wireless connections. Commands to the brake interface may cause the autonomous vehicle's brakes to be applied, engaged, or released. The command to the brake interface may additionally specify an intensity of braking. Commands to the throttle interface may cause the autonomous vehicle's throttle to be actuated, increasing engine/motor speed or decreasing engine/motor speed. Commands to the steering interface may cause the autonomous vehicle to steer left or right of a current heading, for example.

Accordingly, based on inputs from sensors 740, the autonomous driving system 710 may determine an action and may send related commands to vehicle control interface 730 to control the autonomous vehicle.

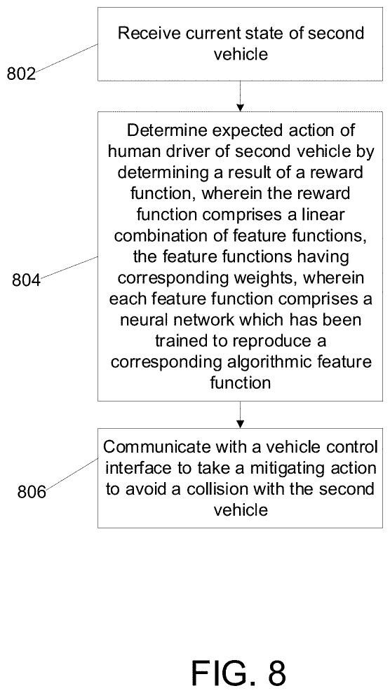

FIG. 8 illustrates an exemplary method in accordance with one or more aspects described herein. In FIG. 8 at step 802, the autonomous driving system may receive a current state of a second vehicle, such as a nearby vehicle. For example, the current state of the second vehicle may be received from a camera that is associated with the autonomous driving system. The camera may detect the presence of the second vehicle and a current state of the second vehicle. In some embodiments, the current state may comprise positional information or a trajectory of the second vehicle. For example, the positional information may correspond to x₁-x₅ as shown in FIG. 6. The current state of the second vehicle may be obtained in various other ways, including via use of various other sensors, including radar, Lidar, and cameras, among others. In some embodiments, the current state of the second vehicle may be obtained via communications with the second vehicle. For example, various vehicle positional information may be received from the second vehicle via wireless communications.

In some embodiments, a make/model of the second vehicle may be determined, or various characteristics may be determined, such as the weight of the vehicle, the height of the vehicle, or various other parameters that may affect the expected handling capabilities of the second vehicle. In addition, various environmental conditions may be determined. For example, via sensors, the autonomous driving system may determine a condition of the road surface (wet, dry, iced, etc.). The autonomous driving system may consider these environmental conditions when determining the intent of the driver of the second vehicle or the expected trajectory of the second vehicle.

At step 804, the autonomous driving system may determine an expected action of a human driver of the second vehicle by determining a result of a reward function (for example, r in FIG. 6), wherein the reward function comprises a linear combination of feature functions, the feature functions having corresponding weights, wherein each feature function comprises a neural network which has been trained to reproduce a corresponding algorithmic feature function. The algorithmic feature function may comprise a function for keeping a speed, avoiding a collision, keeping a heading, or maintaining a lane boundary distance.

In some embodiments, the weights associated with the feature functions may be resultant from preference-based learning of the reward function with human subjects, as discussed above. Furthermore, each neural network may have been trained on results from the preference-based learning. In some embodiments, the feature functions and the weights may be based on an iterative approach comprising simultaneous feature training and weight training to train the reward function, wherein the neural networks are kept fixed while preference-based training is conducted to train the weights, then the weights are kept fixed while the neural networks are trained on the same data obtained during the preference-based training of the weights.

At step 806, the autonomous driving system may, based on the determined expected action of the human driver, communicate with a vehicle control interface of the first vehicle (such as vehicle control interface 730 of FIG. 7) to cause the first vehicle to take a mitigating action, for example to avoid a collision or to avoid an unsafe condition. For example, if the autonomous driving system determines that a second vehicle may enter the lane occupied by the ego-vehicle, the autonomous driving system may cause application of a braking action, in order to avoid a collision with the second vehicle. In various embodiments, the action taken may include invoking a braking action, causing a change in a trajectory, or actuating a throttle. In some examples, an instruction or command causing a vehicle control system to execute one or more evasive maneuvers may be generated and executed by the system. These actions may be taken to avoid a collision with a nearby vehicle, or with other objects. In some embodiments, the actions may be taken to avoid leaving the roadway or departing from a lane of the roadway.

Aspects of the invention have been described in terms of illustrative embodiments thereof. Numerous other embodiments, modifications, and variations within the scope and spirit of the description will occur to persons of ordinary skill in the art from a review of this disclosure. For example, one of ordinary skill in the art will appreciate that the steps disclosed in the description may be performed in other than the recited order, and that one or more steps may be optional in accordance with aspects of the invention.

What is claimed is:

1. A method comprising:
receiving, by a computing device in a first vehicle, a current state of a second vehicle;
based on the current state, determining an expected action of a human driver of the second vehicle by determining a result of a reward function, wherein the reward function comprises a linear combination of feature functions, the feature functions having corresponding weights, wherein each feature function comprises a neural network which has been trained to reproduce a corresponding algorithmic feature function; and
based on the determined expected action of the human driver, communicating with a vehicle control interface of the first vehicle to cause the first vehicle to take a mitigating action to avoid a collision.

2. The method of claim 1, wherein the receiving the current state of the second vehicle comprises receiving the current state of the second vehicle from a camera in the first vehicle.

3. The method of claim 1, wherein the algorithmic feature function comprises a function for keeping a speed, collision avoidance, keeping a heading, or maintaining a lane boundary distance.

4. The method of claim 1, wherein the weights are resultant from preference-based learning of the reward function with human subjects.

5. The method of claim 4, wherein each neural network has been further trained on results from the preference-based learning.

6. The method of claim 5, wherein the feature functions and the weights are based on an iterative approach comprising simultaneous feature training and weight training to train the reward function, wherein the neural networks are kept fixed while preference-based learning is conducted to train the weights, then the weights are kept fixed while the neural networks are trained on the same data obtained during training of the weights.

7. The method of claim 1, wherein the communicating with the vehicle control interface of the first vehicle to cause the first vehicle to take the mitigating action comprises communicating with the vehicle control interface of the first vehicle to cause a braking action or a change in a trajectory of the first vehicle.

8. A method comprising:
determining, by a computing device in a first vehicle, positional information of a second vehicle;
based on the positional information, determining an expected action of a human driver of the second vehicle by determining a result of a reward function, wherein the reward function comprises a linear combination of feature functions, the feature functions having corresponding weights, wherein each feature function comprises a neural network which has been trained to reproduce a corresponding algorithmic feature function; and
based on the determined expected action of the human driver, communicating with a vehicle control interface of the first vehicle to cause the first vehicle to take a mitigating action to avoid a collision with the second vehicle.

9. The method of claim 8, wherein the positional information of the second vehicle is based on a current state of the second vehicle received from a camera in the first vehicle.

10. The method of claim 8, wherein the algorithmic feature function comprises a function for keeping a speed, collision avoidance, keeping a heading, or maintaining a lane boundary distance.

11. The method of claim 8, wherein the weights are resultant from preference-based learning of the reward function with human subjects.

12. The method of claim 11, wherein each neural network has been further trained on results from the preference-based learning.

13. The method of claim 11, wherein the feature functions and the weights are based on an iterative approach comprising simultaneous feature training and weight training to train the reward function, wherein the neural networks are kept fixed while preference-based learning is conducted to train the weights, then the weights are kept fixed while the neural networks are trained on the same data obtained during training of the weights.

14. The method of claim 8, wherein the communicating with the vehicle control interface of the first vehicle to cause the first vehicle to take the mitigating action comprises communicating with the vehicle control interface of the first vehicle to cause a braking action or a change in a trajectory of the first vehicle.

15. A method comprising:
determining, by a computing device in a first vehicle, a trajectory of a second vehicle;
based on the trajectory, determining an expected action of a human driver of the second vehicle by determining a result of a reward function, wherein the reward function comprises a linear combination of feature functions, the feature functions having corresponding weights, wherein each feature function comprises a neural network which has been trained to reproduce a corresponding algorithmic feature function; and
based on the determined expected action of the human driver, communicating with a vehicle control interface of the first vehicle to cause a braking action or a change in a trajectory of the first vehicle, thereby avoiding a collision with the second vehicle.

16. The method of claim 15, wherein the trajectory of the second vehicle is based on a current state of the second vehicle received from a camera in the first vehicle.

17. The method of claim 15, wherein the algorithmic feature function comprises a function for keeping a speed, collision avoidance, keeping a heading, or maintaining a lane boundary distance.

18. The method of claim 15, wherein the weights are resultant from preference-based learning of the reward function with human subjects.

19. The method of claim 18, wherein each neural network has been further trained on results from the preference-based learning.

20. The method of claim 18, wherein the feature functions and the weights are based on an iterative approach comprising simultaneous feature training and weight training to train the reward function, wherein the neural networks are kept fixed while preference-based learning is conducted to train the weights, then the weights are kept fixed while the neural networks are trained on the same data obtained during training of the weights.
